(19) United States
(12) Patent Application Publication
(10) Pub. No.: US 2022/0259849 A1
(43) Pub. Date: Aug. 18, 2022

(54) THERMAL INSULATION PANEL

(71) Applicant: VICAT, L'lsle-d'Abeau (FR)

(72) Inventors: Laury BARNES-DAVIN, Voiron (FR); Benoit MONTAZEAUD, Vienne (FR)

(21) Appl. No.: 17/632,779

(22) PCT Filed: Aug. 3, 2020
(86) PCT No.: PCT/FR2020/051426

§ 371 Date: Feb. 3, 2022

(30) Foreign Application Priority Data
Aug. 5, 2019 (FR) FR1908951

(51) Int. Cl. E04B 1/78; E04C 2/06; C04B 7/02; C04B 7/32; C04B 14/42

(52) U.S. Cl. CPC E04B 1/78; E04C 2/06; C04B 2103/302; C04B 7/32; C04B 14/42; C04B 7/02

(57) ABSTRACT

A thermal insulation panel including a thermal insulation layer formed by a hardened cementitious foam; and at least one reinforcing structural element which is secured to the thermal insulation layer, the at least one reinforcing structural element being apertured and flexible.

### CROSS-REFERENCE TO RELATED APPLICATIONS

This application is a National Stage of PCT Application No. PCT/FR2020/051426 filed on Aug. 3, 2020, which claims priority to French Patent Application No. 19/08951 filed on Aug. 5, 2019, the contents each of which are incorporated herein by reference thereto.

### TECHNICAL FIELD

The present invention concerns a thermal insulation panel, for example for buildings.

### BACKGROUND

In order to substantially reduce the heat losses of a building, it is known to carry out either an external thermal insulation (ETI) which consists in placing thermal insulation panels and different layers of cladding materials, such as for example mineral or organic plasters, PVC, wood, concrete panels or still stone, on the external walls of the building, or internal thermal insulation (ITI) which consists, in particular, in placing thermal insulation panels and different layers of cladding materials on the internal walls of the building.

The thermal insulation panels used for the ETI and ITI may be made for example of polystyrene, polyurethane, cellular concrete or even of glass fiber. However, such thermal insulation panels have many drawbacks.

Indeed, the polystyrene and polyurethane thermal insulation panels have relatively low fire resistance and recyclability and have a considerable environmental impact, and glass fiber thermal insulation panels also have a low recyclability. Furthermore, thermal insulation panels made of cellular concrete are relatively difficult to set up due to their large mass.

### BRIEF SUMMARY

The present invention aims at overcoming all or part of these drawbacks.

The technical problem underlying the invention therefore consists in providing a thermal insulation panel which is recyclable, which has a high fire resistance and which may be easily set up, while having a low environmental impact.

To this end, the present invention concerns a thermal insulation panel, for example for buildings, comprising a thermal insulation layer formed by a hardened cementitious foam; and at least one reinforcing structural element which is secured to the thermal insulation layer, the at least one reinforcing structural element being apertured and flexible, the cementitious foam being obtained by hardening of a cementitious composition comprising at least one hydraulic binder, at least one adjuvant, water and an aqueous foam.

Such a configuration of the thermal insulation panel according to the invention, and in particular the fact that the thermal insulation layer is formed by a cementitious foam, confers a high recyclability on the thermal insulation panel, while substantially reducing the mass of the latter compared to a thermal insulation panel made of cellular concrete.

Furthermore, the presence of the at least one reinforcing structural element provides a high mechanical strength to the thermal insulation panel, although the latter is predominantly formed by a hardened cementitious foam.

Consequently, the thermal insulation panel according to the invention is highly recyclable, has a high fire resistance and may be easily set up, while having a low environmental impact and while having a high mechanical strength.

The thermal insulation panel may also have one or more of the following features, considered alone or in combination.

According to an embodiment of the invention, the at least one reinforcing structural element is at least partly integrated into the cementitious foam.

According to an embodiment of the invention, the at least one reinforcing structural element is completely integrated into the cementitious foam.

According to an embodiment of the invention, the at least one reinforcing structural element forms an outer face of the thermal insulation panel.

According to an embodiment of the invention, the at least one reinforcing structural element comprises at least one flexible textile structure including textile threads.

According to an embodiment of the invention, the at least one flexible textile structure is a textile mesh or a fabric.

According to an embodiment of the invention, the textile threads of the at least one flexible textile structure include glass threads, for example alkali-resistant glass threads.

According to an embodiment of the invention, the textile threads of the at least one flexible textile structure include warp threads and weft threads.

According to an embodiment of the invention, the warp threads and/or the weft threads of the at least one flexible textile structure are composed of glass threads, and for example of alkali-resistant glass threads.

According to an embodiment of the invention, the warp threads and/or the weft threads of the at least one flexible textile structure are composed of silionne threads (registered trademark).

According to an embodiment of the invention, the textile threads, and for example the warp threads and the weft threads, of the at least one flexible textile structure are composed of identical glass threads.

According to an embodiment of the invention, the textile threads, and for example the warp threads and the weft threads, of the at least one flexible textile structure have identical counts (or yarn counts or titers).

According to an embodiment of the invention, each warp thread of the at least one flexible textile structure has a count different from each weft thread of the at least one flexible textile structure.

According to an embodiment of the invention, each weft thread of the at least one flexible textile structure has a count corresponding to twice the count of each warp thread of the at least one flexible textile structure.

According to an embodiment of the invention, each warp yarn of the at least one flexible textile structure has a count comprised between 50 and 300 tex. Each warp thread may, for example, have a count of 68 tex, 136 tex or even 272 tex.

According to an embodiment of the invention, each weft thread of the at least one flexible textile structure has a count comprised between 50 and 600 tex. Each weft thread may have for example a count of 68 tex, 136 tex, 272 tex or even 544 tex.

According to an embodiment of the invention, the at least one flexible textile structure includes a binding coating covering and connecting the textile threads, and for example the warp threads and the weft threads, of the at least one flexible textile structure.

According to an embodiment of the invention, the textile threads, and for example the warp threads and the weft threads, of the at least one flexible textile structure are glued together.

According to an embodiment of the invention, the binding coating is made of PVC or EVA

According to an embodiment of the invention, the textile threads, and for example, the warp threads and the weft threads, of the at least one flexible textile structure are woven or non-woven.

According to an embodiment of the invention, the textile threads, and for example the warp threads and the weft threads, of the at least one flexible textile structure are superimposed and glued together.

According to another embodiment of the invention, the at least one flexible textile structure has a 2×2S, 1×0.5S, 1×1S, 5×3S or still 3×3D texture.

According to a variant of the invention, the at least one flexible textile structure is formed by a multilayer textile complex. The multilayer textile complex includes for example at least one textile mesh and one fabric.

According to an embodiment of the invention, the at least one flexible textile structure includes at least two sheets of warp threads between them is interposed at least one sheet of weft threads, the warp threads and the weft threads being connected to each other at their intersections by the binding coating.

According to an embodiment of the invention, the at least one flexible textile structure has a thickness comprised between 300 and 990 μm.

According to an embodiment of the invention, the at least one flexible textile structure has a mass comprised between 100 and 250 g/m².

According to an embodiment of the invention, each textile thread of the at least one flexible textile structure has a strength comprised between 50 and 300 daN/5 cm, and for example between about 90 and about 250 daN/5 cm.

According to an embodiment of the invention, each warp thread of the at least one flexible textile structure has a strength comprised between 50 and 300 daN/5 cm, and for example between about 90 and about 250 daN/5 cm.

According to an embodiment of the invention, each weft thread of the at least one flexible textile structure has a strength comprised between 50 and 300 daN/5 cm, and for example between about 90 and about 250 daN/5 cm.

According to an embodiment of the invention, each textile thread of the least one flexible textile structure has an elongation at break comprised between 3.5 and 5.5%, and for example between about 4 and about 5%.

According to an embodiment of the invention, each warp thread of the at least one flexible textile structure has an elongation at break comprised between 3.5 and 5.5%, and for example between about 4 and about 5%.

According to an embodiment of the invention, each weft thread of the at least one flexible textile structure has an elongation at break comprised between 3.5 and 5.5%, and for example between about 4 and about 5%.

According to an embodiment of the invention, the textile threads of the at least one flexible textile structure define apertured spaces, also called meshes, and for example a grid of apertured spaces.

According to an embodiment of the invention, the apertured spaces defined by the textile threads are polygonal, and for example rectangular or square.

According to an embodiment of the invention, the apertured spaces defined by the textile threads are square and have at least 3 millimeters on each side, and for example about five millimeters on each side.

According to an embodiment of the invention, the textile threads of the at least one flexible textile structure are interlaced so as to define the apertured spaces.

According to an embodiment of the invention, the warp threads and the weft threads of the at least one flexible textile structure define apertured spaces of at least 3 millimeters on each side, and for example about five millimeters on each side.

According to an embodiment of the invention, the at least one reinforcing structural element includes a plurality of reinforcing structural elements which are secured to the thermal insulation layer, each reinforcing structural element being apertured and flexible. Each reinforcing structural element may for example just consist of a flexible textile structure including textile threads.

According to an embodiment of the invention, the cementitious foam has a thermal conductivity comprised between 0.02 and 0.06 W/m·K, and for example comprised between 0.03 and 0.06 W/m·K, and advantageously comprised between 0.035 and 0.055 W/m·K.

According to an embodiment of the invention, the cementitious foam has a volumetric mass comprised between 50 and 200 kg/m³.

According to an embodiment of the invention, the cementitious foam has a dry volumetric mass comprised between 80 and 150 Kg/m³.

According to an embodiment of the invention, the cementitious composition further comprises at least one water-reducing agent. However, according to a variant of the invention, the cementitious composition could be devoid of water-reducing agent.

According to an embodiment of the invention, the cementitious composition comprised between 0.10 and 0.3% of dry extract of water-reducing agent relative to the weight of hydraulic binder.

According to an embodiment of the invention, the water-reducing agent is a plasticizer or a superplasticizer.

According to an embodiment of the invention, the water-reducing agent is selected from lignosulfonates, hydroxycarboxylic acids, carbohydrates or other organic compounds, such as glycerol, polyvinyl alcohol, sodium alumino-methyl-silicaonate, sulfanilic acid, casein and/or PCP.

According to an embodiment of the invention, the cementitious composition further comprises fibers.

According to an embodiment of the invention, the fibers may be natural, cellulosic, polymeric, organic and/or inorganic fibers. In the case where glass fibers are used, these must have sufficient alkali resistance.

According to an embodiment of the invention, the cementitious composition comprises, for 1 m³ of cementitious composition, 30 to 150 kg of hydraulic binder, 0.03 to 7.5 kg of dry extract of adjuvant, 0 to 2 kg of fibers (and for example from 0 to 1 kg of fibers), 15 to 75 kg of water and the remainder consisting of an aqueous foam.

In the context of the present invention, the term “aqueous foam” defines any type of foam obtained by a mixture of gas bubbles in an aqueous solution. Such an aqueous solution comprises, for example, water and at least one surfactant compound. Advantageously, the gas bubbles have diameters smaller than 1 mm.

According to an embodiment of the invention, the aqueous foam is composed of 92 to 97% by volume of gas, such as air, and of 3 to 8% of an aqueous solution. Advantageously, the aqueous solution is a mixture of water and at least one foaming agent. Such a mixture may be carried out continuously or in batches.

According to an embodiment of the invention, the aqueous foam is obtained using a foam generator, and more particularly by introducing the aqueous solution and a pressurized gas into the foam generator. According to such an embodiment, the aqueous solution is obtained by mixing the water and the at least one foaming agent prior to their introduction into the foam generator.

According to an embodiment of the invention, the foam generator is configured such that the obtained aqueous foam is stable and the gas bubbles of the aqueous foam have diameters smaller than 1 mm.

According to an embodiment of the invention, the foam generator includes a basic body, for example cylindrical, through which the aqueous solution and the pressurized gas are intended to flow, and inserts arranged in the basic body and in contact of which the aqueous solution and the pressurized gas are intended to flow. The inserts may include for example hollow or solid metal parts (for example nuts or eyelets, etc.), metal fibers, plastic fibers, glass beads, etc.

According to an embodiment of the invention, the foaming agent is an organic foaming agent. Advantageously, the foaming agent is derived from an animal or plant protein. The foaming agent may also be a cationic, ionic, nonionic and/or amphoteric surfactant.

According to an embodiment of the invention, the cementitious composition comprises, for 1 m³ of cementitious composition, 50 to 130 kg of hydraulic binder, 0.1 to 5% of dry extract of adjuvant relative to the weight of hydraulic binder, 0 to 2 kg of fibers (and for example 0 to 1 kg of fibers), 25 to 50% of water relative to the weight of hydraulic binder, 0 to 0.3% of dry extract of water-reducing agent relative to the weight of hydraulic binder (and for example between 0.10 and 0.3% of dry extract of water-reducing agent relative to the weight of hydraulic binder) and the remainder consisting of an aqueous foam.

According to an embodiment of the invention, the hydraulic binder includes at least one cement selected from a Portland cement, an aluminous cement, a sulphoaluminous cement and/or a quick-setting natural cement. The hydraulic binder may further include at least one mineral additive, such as silica, calcium carbonate, calcined clays, silica fume, slag, fly ash or pozzolans. The hydraulic binder may include for example several mineral additives, and in particular several mineral additives among the aforementioned ones. Advantageously, the hydraulic binder comprises 0 to 20% of mineral additives relative to the weight of cement.

According to an embodiment of the invention, the cementitious composition includes at least one adjuvant selected from a rheological agent, a water-retaining agent, an air-entraining agent, a thickening agent, a biocide and/or fungicide agent, a water repellent, a dispersing agent, an accelerator, a retarder, a stabilizer, such as a gas bubble stabilizer, and an agent for setting and/or hardening the cementitious composition. The stabilizer is more particularly configured to modify the surface tension of the gas bubbles of the aqueous foam in order to improve the size of the gas bubbles and/or to increase the stability of the gas bubbles.

According to one embodiment of the invention, the at least one adjuvant so includes an accelerator and/or a gas bubble stabilizer.

According to an embodiment of the invention, the cementitious composition includes fibers selected from fibers improving the rheological properties of the cementitious composition and/or fibers improving the mechanical properties, such as the robustness, of the cementitious composition.

According to an embodiment of the invention, the at least one reinforcing structural element has a three-dimensional shape.

According to an embodiment of the invention, the at least one reinforcing structural element has a two-dimensional shape.

According to an embodiment of the invention, the thermal insulation panel has a generally rectangular shape.

According to an embodiment of the invention, the thermal insulation panel has a thickness smaller than or equal to 0.4 m.

According to an embodiment of the invention, the thermal insulation panel has a width smaller than or equal to 0.6 m.

According to an embodiment of the invention, the thermal insulation panel has a length smaller than or equal to 1.2 m.

According to an embodiment of the invention, the at least one reinforcing structural element includes a first reinforcing structural element forming a first outer face of the thermal insulation panel and a second reinforcing structural element forming a second outer face of the thermal insulation panel, the first and second reinforcing structural elements being arranged on either side of the thermal insulation layer. Advantageously, the first and second reinforcing structural elements are distinct from each other and spaced apart from each other.

According to an embodiment of the invention, the at least one reinforcing structural element further includes an intermediate reinforcing structural element integrated into the cementitious foam and arranged between the first and second reinforcing structural elements.

According to an embodiment of the invention, the thermal insulation panel has a generally parallelepipedic shape.

According to an embodiment of the invention, the thermal insulation panel is an outer thermal insulation panel intended to be fastened on an outer wall of a building.

According to another embodiment of the invention, the thermal insulation panel is an inner thermal insulation panel intended to be fastened to an inner wall of a building.

According to an embodiment of the invention, the cementitious composition is prepared at least partly by mixing the aqueous foam and a cementitious grout, the cementitious grout comprising at least water and the hydraulic binder. The mixing of the aqueous foam and the cementitious grout may be performed in batches or continuously.

According to an embodiment of the invention, the cementitious grout is prepared using a mixer, and for example using a high-shear mixer, such as a turbo-mixer or a mixer for injection grout.

According to an embodiment of the invention, the cementitious grout is prepared by introducing water as well as any possible adjuvants, water reducers and/or fibers into the mixer, by homogenizing these components in the mixer, and then by progressively introducing the hydraulic binder into the mixer operating at full power. The mixing of these different components may then be carried on for 2 to 3 minutes.

According to an embodiment of the invention, the at least one adjuvant is integrated into the cementitious composition during the preparation of the cementitious grout, during the production of the aqueous foam, during the mixing of the aqueous foam and the cementitious grout or after mixing of the aqueous foam and the cementitious grout.

According to an embodiment of the invention, the thermal insulation panel further includes a reinforcing structure which is secured to the thermal insulation layer and which is flexible and non-apertured. The reinforcing structure may form for example an outer face of the thermal insulation panel.

According to an embodiment of the invention, the reinforcing structure is a textile structure which is flexible and non-apertured. Such a textile structure may for example consist of a glass fabric, felt, a roving fabric, a rovimat fabric, a glass mat (for example having a weight comprised between 300 and 600 g/m²), a multiaxial fabric, braid glass, a glass wool fabric.

According to an embodiment of the invention, the at least one reinforcing structural element includes a reinforcing structural element which is flexible and apertured and which forms a first outer face of the thermal insulation panel, and the reinforcing structure forms a second outer face of the thermal insulation panel.

According to an embodiment of the invention, the cementitious foam has a porosity comprised between 90 and 98%.

According to an embodiment of the invention, the cementitious foam has a tensile strength higher than 10 KPa.

According to an embodiment of the invention, the cementitious foam has a flexural strength higher than 10 KPa.

According to an embodiment of the invention, the cementitious foam has a compressive strength comprised between 0.05 and 0.5 MPa.

According to an embodiment of the invention, the cementitious foam has a moisture absorption lower than 20%.

According to an embodiment of the invention, the cementitious foam has a frost resistance compliant with the standard NF EN 771-3+A/CN.

According to an embodiment of the invention, the cementitious foam has a reaction to fire A1.

According to an embodiment of the invention, the cementitious foam has a water vapor transmission rate lower than 3 g·h⁻¹·m⁻².

According to an embodiment of the invention, the at least one reinforcing structural element has an aperture ratio, also called perforation ratio, comprised between 25 and 80%. In other words, the surface of the apertured spaces of the at least one reinforcing structural element represents 25 to 80% of the total surface of the at least one reinforcing structural element.

### BRIEF DESCRIPTION OF THE DRAWINGS

Anyway, the invention will be clearly understood from the following description with reference to the appended schematic drawings representing, as a non-limiting example, an embodiment of this thermal insulation panel.

FIG. 1 is a perspective view of a thermal insulation panel according to the invention.

FIG. 2 is a front view of the thermal insulation panel of FIG. 1.

FIG. 3 is a partial longitudinal sectional view of the thermal insulation panel of FIG. 1.

FIG. 4 is a perspective view of a reinforcing structural element of the thermal insulation panel of FIG. 1.

FIG. 5 is a diagram showing the evolution of the force applied on a test body as a function of the deformation of the latter.

### DETAILED DESCRIPTION

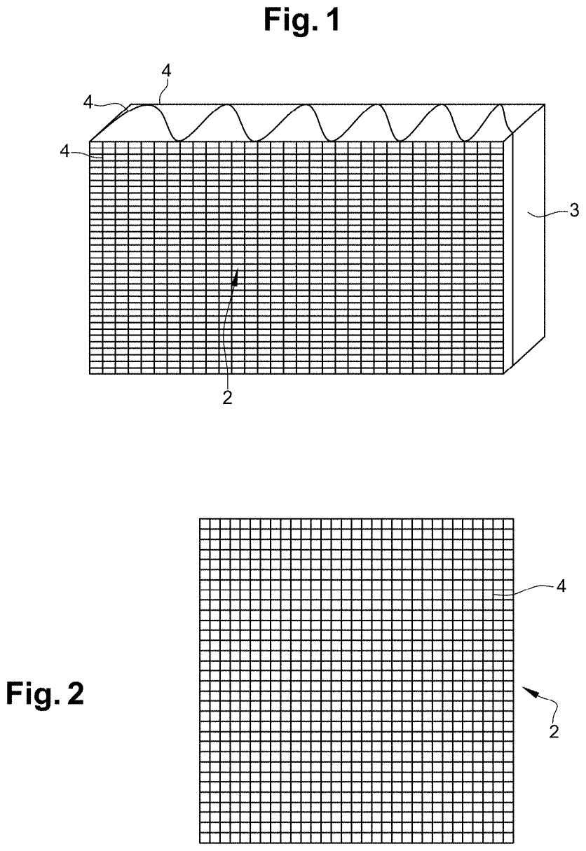

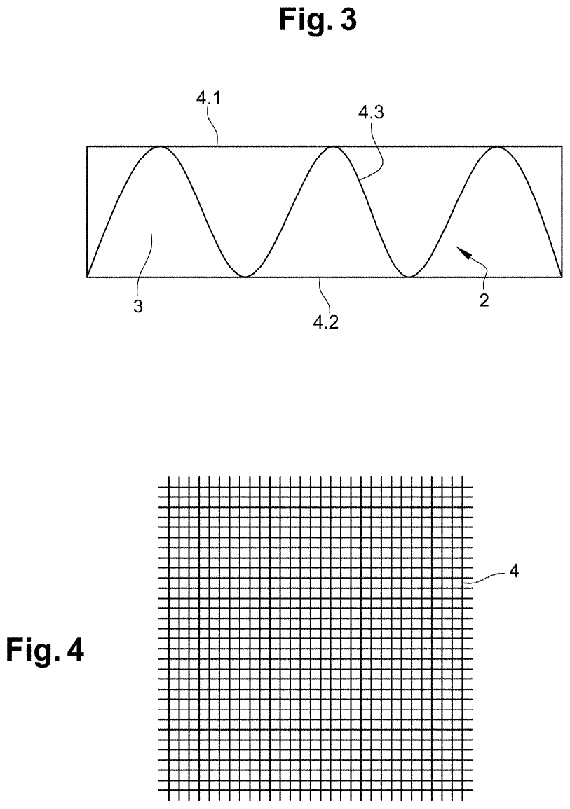

FIGS. 1 to 3 represent a thermal insulation panel 2 adapted to provide external thermal insulation (ETI) of a building, such as for example an individual dwelling, a collective dwelling, an office building, an agricultural or semi-agricultural building. The thermal insulation panel 2 may be used to achieve insulation of a new building and renovate an old building.

The thermal insulation panel 2 advantageously has a generally rectangular shape. For example, the thermal insulation panel 2 may have a thickness smaller than or equal to 0.4 m, a width smaller than or equal to 0.6 m, and a length smaller than or equal to 1.2 m.

The thermal insulation panel 2 comprises a thermal insulation layer 3 formed by a hardened cementitious foam. The cementitious foam advantageously has a thermal conductivity comprised between 0.03 and 0.06 W/m·K, and a volumetric mass comprised between 50 and 200 Kg/m³.

The cementitious foam is formed by hardening of a cementitious composition comprising a hydraulic binder, at least one adjuvant, water, fibers and an aqueous foam.

The hydraulic binder preferably includes at least one cement selected from a Portland cement, an aluminous cement, a sulphoaluminous cement and/or a quick-setting natural cement, and the aqueous foam is advantageously obtained by a mixture of gas bubbles in an aqueous solution which includes for example water and at least one surfactant compound.

According to an embodiment of the invention, the cementitious composition comprises at least one adjuvant selected from a rheological agent, a water-retaining agent, an air-entraining agent, a thickening agent, a biocide and/or fungicide agent, a water-repellent agent, a dispersing agent, an accelerator, a retarder and an agent for setting and/or hardening the cementitious composition, and the fibers are selected from fibers improving the rheological properties of the cementitious composition and/or fibers improving the mechanical properties of the cementitious composition, and for example glass fibers.

According to an embodiment of the invention, the cementitious composition comprises, for 1 m³ of cementitious composition, 30 to 150 kg of hydraulic binder, 5 to 20 kg of adjuvant, 0 to 2 kg of fibers (and for example 0 to 1 kg of fibers), 15 to 75 kg of water and the remainder consisting of an aqueous foam (also denoted aqueous foam q.s.).

The thermal insulation panel 2 further comprises several reinforcing structural elements 4 which are secured to the thermal insulation layer 3.

According to the embodiment represented in the figures, the thermal insulation panel 2 comprises a first reinforcing structural element 4.1 forming a first outer face of the thermal insulation panel 2 and a second reinforcing structural element 4.2 forming a second outer face of the thermal insulation panel 2. Thus, the first and second reinforcing structural elements 4.1, 4.2 are arranged on either side of the thermal insulation layer 3, and each has a two-dimensional shape.

The thermal insulation panel 2 further includes an integrated intermediate reinforcing structural element 4.3, and preferably completely integrated, into the cementitious foam and therefore disposed between the first and second reinforcing structural elements 4.1, 4.2. Advantageously, the intermediate reinforcing structural element 4.3 has a three-dimensional shape, and may have for example a plurality of undulations which may be concave and/or convex.

Each reinforcing structural element 4 more particularly comprises a flexible textile structure including textile threads which may be woven or simply superimposed and glued together. Each flexible textile structure may have for example a thickness comprised between 300 and 990 μm, and a mass comprised between 100 and 250 g/m².

Each flexible textile structure may be formed for example by a textile mesh or by a fabric. However, according to a variant of the invention, each flexible textile structure could be formed by a multilayer textile complex which could for example include at least one textile mesh and one fabric.

According to an embodiment of the invention, the textile threads of each flexible textile structure include warp threads and weft threads, and the warp threads and the weft threads of each flexible textile structure are composed of glass threads, and for example of silionne threads (registered trademark). The warp threads and the weft threads of each flexible textile structure may be composed of identical glass threads, i.e. made of the same material and having identical counts. The warp threads and the weft threads of each flexible textile structure may in particular have a count of 68 tex.

According to another embodiment of the invention, each warp thread of a flexible textile structure may have a count different from that of each weft thread of said flexible textile structure. Thus, each weft thread of a flexible textile structure may have for example a count corresponding to twice the count of each warp thread of said flexible textile structure. Each flexible textile structure may in particular be formed of warp threads having a count of 68 tex and of weft threads having a count of 136 tex, or warp threads having a count of 136 tex and weft threads having a count of 272 tex or warp yarns having a count of 272 tex and weft threads having a count of 544 tex.

Advantageously, each flexible textile structure further includes a binding coating covering and connecting the textile threads, and for example the warp threads and the weft threads, of said flexible textile structure. The binding coating of each flexible textile structure is more particularly configured to glue the warp threads and the respective weft threads together. The binding coating of each flexible textile structure may be made for example of PVC or EVA.

According to an embodiment of the invention, each warp thread of each flexible textile structure has a strength comprised between 90 and 250 daN/5 cm, and each weft thread of each flexible textile structure has a strength comprised between 90 and 250 daN/5 cm.

According to an embodiment of the invention, each warp thread of each flexible textile structure has an elongation at break comprised between about 4 and 5%, and each weft thread of each flexible textile structure also has an elongation at break comprised between 4 and 5%.

The table replicated below indicates different characteristics of five different flexible textile structures that may be used to form the different reinforcing structural elements 4.

TABLE 1

| | | | | | | Resitance | | Elongation | |
|---|---|---|---|---|---|---|---|---|---|
| | | | | | | (DaN/5 cm) | | (%) | |
| | Warp | Weft | Weight | Thickness | Binding | Warp | Weft | Warp | Weft |
| Contexture | thread | thread | (g/m³) | (μm) | coating | thread | thread | thread | thread |
| 2 × 2S | Silionne | Silionne | 205 | 600 | PVC | 240 | 240 | 5 | 5 |
| | 136 tex | 272 tex | | | | | | | |
| 1 × 0.5S | Silionne | Silionne | 195 | 850 | PVC | 220 | 145 | 4.5 | 4.5 |
| | 272 tex | 544 tex | | | | | | | |
| 1 × 1S | Silionne | Silionne | 225 | 850 | PVC | 240 | 250 | 5 | 5.2 |
| | 272 tex | 544 tex | | | | | | | |
| 5 × 3S | Silionne | Silionne | 135 | 350 | PVC | 150 | 170 | 4.5 | 4.5 |
| | 68 tex | 136 tex | | | | | | | |
| 3 × 3D | Silionne | Silionne | 115 | 570 | EVA | 90 | 90 | 4 | 4 |
| | 68 tex | 68 tex | | | | | | | |

The different silionne threads (registered trademark) mentioned in the table replicated above are advantageously made of E glass.

According to another embodiment of the invention, each flexible textile structure may include at least two sheets of warp threads between which is interposed at least one sheet of weft threads, the warp threads and the weft threads being connected together at their intersections by the corresponding binding coating.

The thermal insulation panel 2 according to the present invention may be fastened to a wall in different ways, and for example according to a glued and wedged-anchored set-up. After fastening of the thermal insulation panel 2, the latter is advantageously covered with a finishing coating, such as a layer of plaster which is deposited on the visible outer face of the thermal insulation panel 2. The finishing coating may also be fastened to the wall so as to cover the thermal insulation panel 2 and form a ventilated facade.

### Example 1: Composition of the Cementitious Foam

The thermal insulation layer 3 may be formed for example by a cementitious foam composed of a hydraulic binder up to 200 kg/m³, an adjuvant up to 5 kg/m³, water up to 100 kg/m³, a foaming agent up to 2.5 kg/m³ and aqueous foam up to 830 l/m³. After hardening, the cementitious foam has a volumetric mass of 240 kg/m³.

### Example 2: Incorporation of a Flexible Textile Structure into the Cementitious Foam

Making of Two Test Bodies:

A first test body (CE1) is made from a cementitious foam as described in example 1 without incorporating a flexible textile structure into the cementitious foam. A second test body (CE2) is made by integrating a flexible textile mesh with a 2×2S contexture at mid-height in a cementitious foam as described in example 1 before hardening of said cementitious foam. The first and second test bodies have the same dimensions, namely: 60×60×10 cm.

Mechanical Characterization:

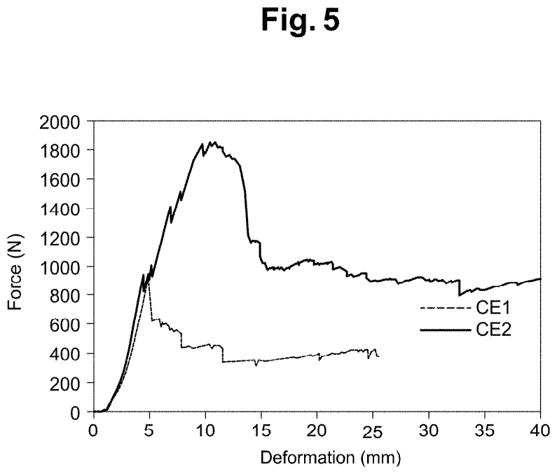

After 28 days of curing, the first and second test bodies are characterized by punching using a support surface of 15×15 cm. For the test, the first and second test bodies are placed on a 50×50 cm frame. The obtained results are reported in FIG. 5.

As shown in FIG. 5, the integration of a flexible textile structure in the cementitious foam has allowed the increase of the mechanical properties of the hardened cementitious foam. In particular, the maximum force has been multiplied by two, as the recovery capacity due to the flexible textile structure.

### Example 3: Complementary Compositions

It is possible to extend the integration of flexible textile structure to other cementitious foam compositions such as:
a cementitious foam composed of a hydraulic binder up to 110 kg/m³, an adjuvant up to 5 kg/m³, water up to 65 kg/m³, a foaming agent up to 2.5 kg/m³ and an aqueous foam up to 900l/m³. After hardening, the cementitious foam has a volumetric mass of 130 kg/m³;
a cementitious foam composed of a hydraulic binder up to 50 kg/m³, an adjuvant up to 5-20 kg/m³, water up to 25 kg/m³, a foaming agent up to 2.5 kg/m³ and an aqueous foam up to 900 l/m³. After hardening, the cementitious foam has a volumetric mass of 70 kg/m³;
a cementitious foam composed of a hydraulic binder up to 110 kg/m³, an adjuvant up to 5 kg/m³, water up to 55 kg/m³, a foaming agent up to 2.5 kg/m³ and an aqueous foam up to 900l/m³. After hardening, the cementitious foam has a volumetric mass of 130 kg/m³;
a cementitious foam composed of a hydraulic binder up to 50 kg/m³, a liquid adjuvant (with a dry extract of 30%) up to 5-8 kg/m³, water up to 25 kg/m³, a foaming agent up to 2.5 kg/m³ and an aqueous foam up to 900 l/m³. After hardening, the cementitious foam has a volumetric mass of 70 kg/m³.

### Example 4: Complementary Composition

It is possible to extend the integration of flexible textile structure into a cementitious foam composed of a hydraulic binder up to 60 kg/m³, a stabilizing adjuvant, in aqueous form, up to 1 kg/m³ (i.e. 0.3 kg/m³ of dry extract of stabilizing adjuvant), water up to 18 kg/m³, a water-reducing agent, in aqueous form, up to 0.3 kg/m³ (i.e. 0.1 kg/m³ of dry extract of water-reducing agent), a foaming agent up to 1.1 kg/m³, and an aqueous foam up to 50 kg/m³.

As goes without saying, the invention is not limited to the sole embodiment of this thermal insulation panel, described above as example, but in the contrary it encompasses all variants thereof. Thus, in particular, the thermal insulation panel according to the invention could also be used in particular to achieve internal thermal insulation (ITI).

1. A thermal insulation panel, comprising:
a thermal insulation layer formed by a hardened cementitious foam; and
at least one reinforcing structural element which is secured to the thermal insulation layer, the at least one reinforcing structural element being apertured and flexible, the hardened cementitious foam being obtained by hardening of a cementitious composition comprising at least one hydraulic binder, at least one adjuvant, water and an aqueous foam.

2. The thermal insulation panel according to claim 1, wherein the at least one reinforcing structural element is at least partly integrated into the hardened cementitious foam.

3. The thermal insulation panel according to claim 1, wherein the at least one reinforcing structural element is completely integrated into the hardened cementitious foam.

4. The thermal insulation panel according to claim 1, wherein the at least one reinforcing structural element forms an outer face of the thermal insulation panel.

5. The thermal insulation panel according to claim 1, wherein the at least one reinforcing structural element comprises at least one flexible textile structure including textile threads.

6. The thermal insulation panel according to claim 5, wherein the at least one flexible textile structure is a textile mesh or a fabric.

7. The thermal insulation panel according to claim 5, wherein the textile threads of the at least one flexible textile structure include glass threads.

8. The thermal insulation panel according to claim 5, wherein the at least one flexible textile structure includes a binding coating covering and connecting the textile threads of the at least one flexible textile structure.

9. The thermal insulation panel according to claim 5, wherein the textile threads of the at least one flexible textile structure are woven.

10. The thermal insulation panel according to claim 1, wherein the hardened cementitious foam has a thermal conductivity comprised between 0.02 and 0.06 W/m·K.

11. The thermal insulation panel according to claim 1, wherein the hardened cementitious foam has a volumetric mass comprised between 50 and 200 Kg/m³.

12. The thermal insulation panel according to claim 1, wherein the cementitious composition further comprises fibers.

13. The thermal insulation panel according to claim 1, wherein the at least one hydraulic binder includes at least one cement selected from a Portland cement, an aluminous cement, a sulphoaluminous cement and/or a quick-setting natural cement.

14. The thermal insulation panel according to claim 1, wherein the at least one reinforcing structural element includes a first reinforcing structural element a first outer face of the thermal insulation panel and a second reinforcing structural element forming a second outer face of the thermal insulation panel, the first and second structural reinforcement elements being arranged on either side of the thermal insulation layer.

15. The thermal insulation panel according to claim 14, wherein the at least one reinforcing structural element further includes an intermediate reinforcing structural element integrated into the hardened cementitious foam and arranged between the first and second reinforcing structural elements.

16. The thermal insulation panel according to claim 1, wherein the cementitious composition further comprises at least one water-reducing agent.

17. The thermal insulation panel according to claim 1, wherein the cementitious composition comprises, for 1 m³ of cementitious composition, 50 to 130 kg of hydraulic binder, 0.1 to 5% of dry extract of adjuvant relative to a weight of hydraulic binder, 0 to 2 kg of fibers, 25 to 50% of water relative to the weight of hydraulic binder, 0 to 0.3% of dry extract of water-reducing agent relative to the weight of hydraulic binder and the remainder consisting of an aqueous foam.

18. The thermal insulation panel according to claim 2, wherein the at least one reinforcing structural element is completely integrated into the hardened cementitious foam.

19. The thermal insulation panel according to claim 2, wherein the at least one reinforcing structural element forms an outer face of the thermal insulation panel.

20. The thermal insulation panel according to claim 2, wherein the at least one reinforcing structural element comprises at least one flexible textile structure including textile threads.
